(19) United States
(12) Patent Application Publication
(10) Pub. No.: US 2011/0018713 A1
(43) Pub. Date: Jan. 27, 2011

(54) Wireless Identification Device With Tamper Protection And Method Of Operating Thereof

(75) Inventor: Lior Yehoshua, Hod Hasharon (IL)

Correspondence Address: The Law Office of Michael E. Kondoudis, 888 16th Street, N.W., Suite 800, Washington, DC, 20006, US

(73) Assignee: ROSEMAN ENGINEERING LTD., Givatayim (IL)

(21) Appl. No.: 12/867,962

(22) PCT Filed: Feb. 23, 2009
(86) PCT No.: PCT/IB2009/000328

§ 371 Date: Aug. 17, 2010

Related U.S. Application Data
(60) Provisional application No. 61/064,185, filed on Feb. 21, 2008.

(51) Int. Cl. G08B 13/14

(52) U.S. Cl. 340/572.3

(57) ABSTRACT

There is provided according to some embodiments of the invention a wireless identification device (‘WIDD’) with tamper protection. According to some embodiments of the invention, the WIDD may include a tamper protection sensor and a processing module. The tamper protection sensor may be configured for sensing a physical property related to at least one essential functional component of the WIDD, the physical property is affected by an attempt to physically remove the at least one essential functional component of the WIDD from a surface to which it is attached during initialization. The processing module is adapted to receive or obtain, at a substantially high frequency, data corresponding to readings from the tamper protection sensor. The processing module is responsive to a relatively sharp and abrupt non-transient change in the level of the physical property for initiating a disablement action or procedure.

### CROSS-REFERENCE TO RELATED APPLICATIONS

This application claims the benefit of U.S. Provisional Patent Application No. 61/064,185, filed Feb. 21, 2008, the full disclosures of which is incorporated herein by reference for all purposes.

### FIELD OF THE INVENTION

The present invention is in the field of wireless identification devices and protection thereof against tampering attempts.

### LIST OF REFERENCES

The following references are considered to be pertinent for the purpose of understanding the background of the present invention:

U.S. Pat. No. 6,002,343 to Leibman et al.

U.S. Pat. No. 5,237,307 to Gritton et al.

U.S. Pat. No. 7,301,462 to Reeves et al.

U.S. Pat. No. 6,900,719 to Roseman.

International Application Publication No. WO08001375 to Gabai et al.

International Application Publication No. WO07092482 to Tiernay et al.

### BACKGROUND OF THE INVENTION

Wireless identification devices (“WIDD” or “WIDDs” in the plural form) are widely used today. WIDDs usually include a storage medium for storing identification data and possibly also additional data and a wireless communication module which enable the WIDD to communicate the identification data. The identification data is usually substantially unique.

One area where WIDDs are commonly used is automatic identification and payment in automatic transaction systems. A purchasing entity can use a WIDD to identify itself in a transaction involving the purchase of goods or services, and a vendor or service provider may use the identification provided by the WIDD to authorize the transaction with the respective entity and facilitate payment for the service or goods.

Sometimes, the WIDD is attached to a certain object and facilitates transactions involving that object. One example of a service where WIDDs are successfully used in this manner is vehicle refueling. The WIDDs used in conjunction with automatic fuelling systems are usually installed near a vehicle's fuel inlet. Some identification data which identifies the vehicle, its owner and/or the payer is usually stored on the WIDD. The identification data is usually programmed into the WIDD during initialization of the WIDD and is stored within a nonvolatile memory unit of the WIDD. In some cases the initialization of the WIDD requires certain software procedures and/or unique hardware which cannot be easily hacked. Implementing such control measures over the initialization of the WIDD provides some barrier against WIDD misuse. However, a culprit may still remove the WIDD from the vehicle and unlawfully tamper with the WIDD. As an example, the culprit may impermissibly attach the WIDD to a different vehicle and use the stolen WIDD to purchase a service or goods at someone else's expense.

### SUMMARY OF THE INVENTION

There is provided according to some embodiments of the invention a wireless identification device (“WIDD”) with tamper protection. According to some embodiments of the invention, the WIDD may include a tamper protection sensor and a processing module. The tamper protection sensor may be configured for sensing a physical property related to at least one essential functional component of the WIDD, the physical property is affected by an attempt to physically remove the at least one essential functional component of the WIDD from a surface to which it is attached during initialization. The processing module is adapted to receive or obtain, at a substantially high frequency, data corresponding to readings from the tamper protection sensor. The processing module is responsive to a relatively sharp and abrupt non-transient change in the level of the physical property for initiating a disablement action of procedure.

In some embodiments, the WIDD may further include a storage module, a communication module and a power source. The storage module may be adapted to substantially permanently store transaction enabling data in the WIDD. The communication module adapted to receive incoming signals arriving at the WIDD and/or to transmit signals out of the WIDD to external components of an automatic transaction system. The communication module may include a transceiver. The communication module may also include an antenna for enabling wireless communication. The power source may be configured for powering components of the WIDD which require power for their operation.

In some embodiments, the essential functional component is one or a combination of the following: a storage module, a processing module, a communication module, an antenna and/or a power source.

In some embodiments the surface to which the WIDD is attached during initialization is opaque and the WIDD may further include a casing and fastening, coupling or attachment means. The casing may be configured to holding therewithin the at least one essential functional component of the WIDD, the casing is substantially opaque except for at least a portion of one face of the casing which is intended for being attached to the surface during initialization. The fastening, coupling or attachment means are configured for attaching the casing to the surface to which the WIDD is attached during initialization, the fastening, coupling or attachment means are substantially opaque thereby providing an optical seal in between the substantially opaque casing and a substantially opaque surface. The tamper protection sensor may be a light sensitive sensor that is configured to measure the amount of light within the casing.

According to further embodiments, the antenna is physically removed from the transceiver and from the tamper protection sensor and is operatively connected to the transceiver and to the tamper protection sensor through wires passing through a hole within a substantially solid surface. The hole is small enough to prevent the passage therethrough of either the antenna or the transceiver. The tamper protection sensor includes an inductance sensor that is adapted to measure of the amount of inductance created by the antenna.

In yet further embodiments the processing module is adapted to detect from the readings by the inductance sensor a relatively sharp and abrupt non-transient change in the level of the inductance of the antenna which corresponds to a severing of the wires connected to the antenna. The processing module is responsive to the change for initiating the disablement action or procedure.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram illustration of a WIDD with tamper protection, according to some embodiments of the invention;

FIG. 2A is a block diagram illustration of a WIDD with a light sensitive tamper protection sensor, while the WIDD is secured to a surface to which it is supposed to remain attached throughout its service, according to some embodiments of the invention;

FIG. 2B, which is a block diagram illustration of a WIDD with a light sensitive tamper protection sensor, while the WIDD is lifted off the surface to which it is supposed to remain attached throughout its service, according to some embodiments of the invention;

FIG. 3 is a block diagram illustration of a WIDD with an inductance sensor, according to some embodiments of the invention;

FIGS. 4A and 4B are block diagrams of two respective implementations of a WIDD with a metal proximity detector, according to some embodiments of the invention;

FIG. 4C is a graph showing the variation of an inductor's inductance as a function of the inductor's distance from a metal surface; and

FIG. 5, is a block diagram illustration of a WIDD with a pressure sensor, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating”, “assigning”, “controlling”, “authorizing” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

According to one aspect of the present invention there is provided a wireless identification device (“WIDD”) with tamper protection. Further aspects of the present invention relate to a method of protecting a WIDD against tampering. A WIDD device according to embodiments of the invention is suitable for use in conjunction with an automatic fuelling system. There is now provided a description of a generic automatic fuelling system. The automatic fuelling system described below is provided as one example of an automatic transaction system. Some embodiments of the invention may be implemented in conjunction with other types of automatic transaction systems and such embodiments are not necessarily limited to automatic refueling systems. It would also be appreciated that the description of the fueling system provided herein is general in nature and relates only to the basic details of typical automatic fuelling systems.

Automatic fuelling systems are well known. One example of an automatic fueling system is the RFC2500—Roseman Fuel Controller by Roseman Engineering Ltd. of Givataim, Israel. Commonly, an automatic fuelling system includes a wireless reader that is coupled to or integrated with a fuel dispenser. The reader is capable of communicating with the WIDD to obtain a unique identifier or any other information that is stored in the WIDD and which is required to facilitate the refueling transaction (and possibly the sale of goods and/or other services). The reader typically communicates directly or through a relay with a central control facility of the automatic fuelling system. The central control facility is typically implemented as a server and is responsible for authorizing or refusing a transaction based on the respective identification data. The central control facility communicates the authorization data or the refusal to the fuel dispenser.

Having described a generic automatic fuelling system, there is now provided a general description of a WIDD that may be used in conjunction with an automatic fuelling system. It would be appreciated however, that some embodiments of the invention may be implemented in conjunction with other types of WIDD that are used together with different automatic transaction systems. It would be further appreciated that in further embodiments of the invention, the structure of the WIDD may vary from the basic structure described hereinbelow.

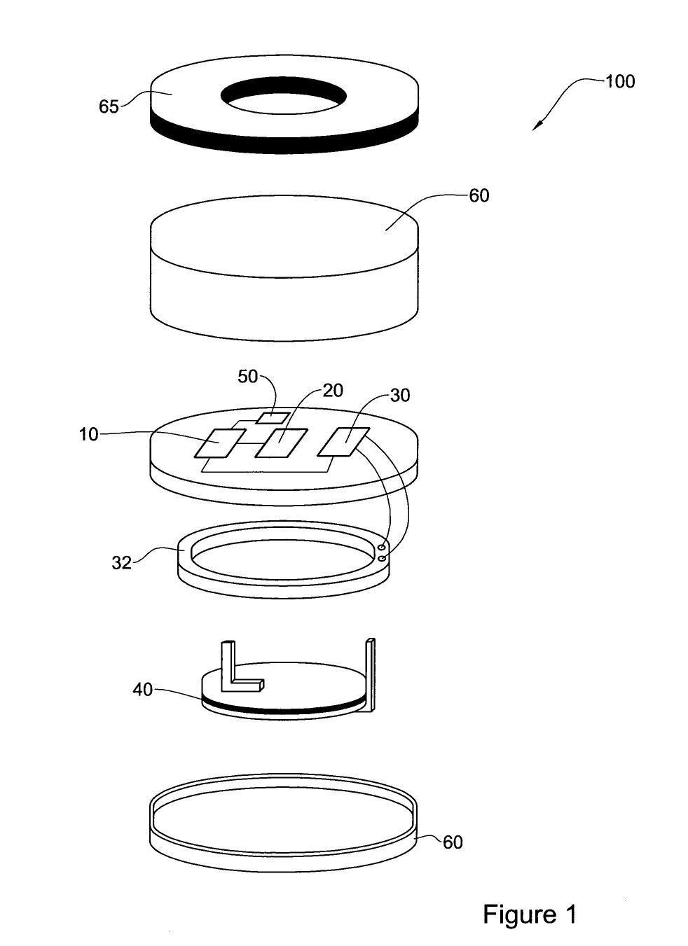

Reference is now made to FIG. 1, which is a block diagram illustration of a WIDD with tamper protection, according to some embodiments of the invention. In some embodiments the WIDD 100 may be attachable to a surface of a vehicle and may facilitate an automatic or at least partially or semi automatic fueling service(s) for the vehicle. In further embodiments, the WIDD 100 may be configured to provide a compatible reader (not shown) with certain data which is essential for facilitating a transaction. The transaction may be but is not necessarily related to the vehicle to which the WIDD 100 is attached.

By way of example, the reader may be part of an automatic (or partially automatic) fuelling system and the data stored on the WIDD 100 and communicatable by the WIDD 100 may be required at least in order to authorize a fueling transaction involving the vehicle to which the WIDD 100 is attached. In some embodiments, each WIDD 100 may hold a substantially unique identification data item, so that each WIDD 100 can be uniquely identified by the identification data stored therein. However, in further embodiments and in some implementations of the proposed invention, the data that is provided by the reader to a transaction may not necessarily be unique. Rather, in some embodiments, one or more different WIDDs may share a common transaction enabling data item. For example, a certain group of WIDDs may be programmed with the credit number of a common payer and each WIDD in this group may be adapted to provide a compatible reader with the credit number that is common to all WIDDs in the group. The credit number (or any other transaction enabling data) provided by any one of the WIDDs in the group may facilitate a certain transaction with an automatic (or partially or semi automatic) transaction system. In further embodiments, the identification data may include or may be associated with one or more of the items in the following non-limiting list: a substantially unique serial number (e.g., GUID), the ID number or social security number of the owner of the vehicle or of the payer for the transactions involving the WIDD, the vehicle's registration number, the fuel type, a transaction limit, etc. It would be appreciated that in some embodiments, in addition to the data that is essential for facilitating a transaction with automatic (or partially or semi automatic) transaction system, the WIDD 100 may hold additional information and may be adapted to communicate such additional information to a compatible reader. Although such additional information may not be essential to facilitate the transaction, it may enable further insight or facilitate advanced or otherwise augmented services to the car owner, to the service provider, to the payer and/or to any other party which is involved or otherwise associated with the transaction.

According to some embodiments, a WIDD 100 may include a processing module 10, a data storage module 20 and a communication module 30. The processing module 10 may be configured at the central processing facility for the WIDD 100 and its various components. In some embodiments the processing module 10 may be configured to control the operation of the WIDD 100 and its components. In one embodiment, the processing module 10 may include ASIC (application specific integrated circuit) components, FPGA programmable gate arrays) components, and/or general processing platforms such as the 8051 microcontroller family by Intel Corp. of Santa Clara, Calif. The processing module 10 may be configured to receive incoming requests or instructions arriving, for example, from a reader (not shown) and through the communication module 30. The processing module 10 may be adapted to process incoming requests, generate a respective response and communicate the response through the communication module 30.

In further embodiments, the processing module 10 may also be adapted to perform other operations which involve processing of data, including processing of data received or obtained from a tamper protection sensor 50. As will be described in further detail below, the processing module 10 may process the data received from the tamper protection sensor 50 to detect readings or parameters or other information that is/are indicative of a tampering attempt. The processing module 10 may implement one or more rules, criteria, thresholds and/or functions to determine based on the readings or parameters from the tamper protection sensor 50 that a tamper attempt is taking place. In case readings which indicate a tamper attempt is detected, the processing module 10 may initiate a disablement action or procedure. The disablement action or procedure initiated by the processing module 10 may be configured to cause the WIDD 100 or any of its essential components to become inoperable or to operate in a manner which is inappropriate or inadequate for facilitating a transaction involving an interaction with WIDD 100, including modifying, deleting and/or rendering inaccessible certain data stored in the WIDD 100 which is necessary to facilitate or otherwise enable a transaction involving an interaction with the WIDD 100. For example, the disablement action or procedure may cause one or more of the following: modifying, deleting and/or rendering inaccessible certain data stored in the WIDD 100 which is necessary to facilitate or otherwise enable a transaction involving the WIDD 100 (such as the transaction enabling data), block inbound and/or outgoing data transmissions to and/or from the WIDD 100, block access to the storage module 20, etc.

In some embodiments, the disablement action or procedure may be configured so that the disablement of the WIDD 100 may be reversed under certain circumstances using a particular hardware component and/or software program which are not readily available and which cannot be readily replicated and/or utilized. For example, according to some embodiments, the disablement action or procedure is configured so that its effect can be reversed only by using a certain external hardware programmer that is available and used within a controlled environment, such as a special support facility. Further by way of example, in order to initiate the process which reverses the disablement action or procedure, a certain password must be provided. The tamper protection sensor 50 and further details about the processing of the data from the tamper protection sensor 50 shall be described below.

According to some embodiments, the processing module 10 may be configured to implement at least one power saving mode. For example, the processing module 10 may be adapted to remain in a sleep mode so long as no processing activity or processing requests are pending. Further by way of example, the processing module 10 may switch out-off a default sleep mode and enter an active mode in response to an incoming communication arriving through the communication module 30. According to yet another example which is contemplated as part of some embodiments, the processing module 10 may switch out-off a default sleep mode and enter an active mode in response to a reading or an indication received from the tamper protection sensor 50. According to an alternative example which is contemplated as part of further embodiments, the processing module 10 may be configured to intermittently wake up (switch from a sleeping mode to an active mode) and interrogate the tamper protection sensor 50. The processing module 10 may be adapted to process the sampled data from the tamper protection sensor 50 to determine if a tamper attempt is taking place, as will be further described below.

The storage module 20 may include a storage medium and possibly also storage management hardware and/or software. The storage module 20 may be adapted to substantially permanently store transaction enabling data in the WIDD 100. For example, the storage module 20 may include one or more non-volatile storage units. As was mentioned above, each WIDD 100 may store identification data that is substantially globally unique and the substantially unique identification data may be used by an automatic transaction system as the transaction enabling data. However, further embodiments of the invention are not limited in this respect, and in further embodiments a certain group of WIDDs may be associated with and may store therein common transaction enabling data. For example, a group of WIDDs which share a common payer may be associated and may store therein a common credit card number or identifier. However, in still further embodiments, WIDDs which are associated with a common payer or share any other similarity may be programmed with a different and substantially unique identification data (e.g., a globally unique WIDD serial number or GUID) which is defined by an automatic transaction system as the transaction enabling data, and the information with respect to the common payer or other similarity is stored elsewhere, for example, in a central control facility of the automatic transaction system. The payer information in the central control facility may be linked to the unique identification data of each one of the WIDDs associated with this payer.

The storage module 20 may be used to store further data in addition to the transaction enabling data. In addition to the types of information mentioned above, the storage module 20 may be used to store the data items in the following, non-limiting, list: the code of the programs stored in the WIDD 100, certain parameters which may be used in certain processes running on the WIDD 100, etc. Additional data which may be stored within the storage module 20 may include certain details which are associated with the vehicle to which the WIDD 100 is attached, the payer for the transaction or service, etc. Such additional data may include for example, but is not limited to the following: a fuel type, a maximum fuelling limit, a maximum transaction value, payer details, vehicle details (e.g., vehicle registration number), etc.

The communication module 30 may include the components necessary to receive incoming signals and/or to transmit signals to the external components of the automatic fueling system, such as a transceiver. The communication module 30 may also be adapted to encode and decode communications as necessary and may include for example an encoder-decoder unit. For example, the communication to and from the WIDD 100 may be encrypted and the communication module 30, either independently or in cooperation with the processing module 10, may be adapted to decrypt and encrypt incoming and outgoing data, respectively.

The communication module 30 may include an antenna 32, and the antenna 32 may provide wireless communication capabilities by enabling receipt and/or transmission of radio signals. According to certain embodiments, the antenna 32 may be configured for being installed near or around the respective vehicle's fuel inlet. In further embodiments, the antenna is a ring coil type antenna. It would be appreciated that positioning the antenna 32 near the fuel inlet may enable to configure a nozzle reader so that it reads the WIDD 100 only when the nozzle is inside the vehicle's fuel inlet. However, according to further embodiments of the invention, the antenna 32 and other components of the WIDD 100 may be placed at or attached to other locations on or within the vehicle. For example, the WIDD 100 including the antenna 32 may be attached to the windowpane of the vehicle.

In some non-limiting embodiments, the communication module is configured to operate (i.e., transmit and receive communications) at very low frequencies which, as is well known, are less affected by metal. It would be appreciated that in some embodiments of the invention, the WIDD 100 may be required to operate and wirelessly communicate with a reader while being at least partially surrounded by metal surfaces.

In some embodiments, the WIDD 100 may include a power source (not shown), such as a battery 40. The power source may provide the WIDD 100 and any of its components with the energy necessary for carrying out its various operations. The power source may be a power-cell unit or units that are designed to operate safely within atmospheric explosive environments.

According to some embodiments of the invention, the components of the WIDD 100 or at least part of which, may be packed within a casing or a package 60. The components of the WIDD may be formed or shaped so that they fit inside the package 60. The casing or package 60 with the components of the WIDD 100 may be attached to a surface of the vehicle. In some embodiments and as part of certain aspects of the invention, a particular design of package 60 may benefit the operation of the tamper protection sensor 50. In other embodiments and as part of other aspects of the invention, the design of the package 60 is not significant. These details of the invention are described below with reference to the respective aspects of the invention.

In some embodiments, the casing 60 is attached to a surface which is characterized by specific physical properties. In different embodiments of certain aspects of the invention which are described below, a specific type of tamper protection sensor 50 may be used to protect against impermissible separation or removal of the casing 60 from the surface to which it is attached. Some of the tamper protection sensors 50 mentioned below may benefit in some embodiments from the attachment of the casing 60 to a surface which is characterized by specific physical properties. Some of the tamper protection sensors 50 mentioned below may benefit in some embodiments from the attachment of the casing 60 to a certain area of the vehicle. These details of the invention are described below with reference to the respective aspects of the invention. In further embodiments and as part of certain aspects of the invention, any surface is considered appropriate for attaching the casing 60. Where there is no mention of a specific attachment surface or location which benefits the operation of the tamper protection sensor 50, any attachment surface is considered appropriate. Furthermore, it should be appreciated that any reference made herein to the packaging of the sensor within the casing is non-limiting. According to a more general perspective and in accordance with some embodiments, the sensor may be used to protect against tamper attempts by sensing a change related to one or more essential functional components of the WIDD 100, whether or not collectively packed in a single case.

According to some embodiments, the package 60 may include fastening, coupling or attachment means 65 for enabling attachment of the casing 60 to the surface of the vehicle. Examples of fastening, coupling or attachment means 65 include double sided stickers, screws, catches, latches, magnetic or electromagnetic attachment mechanisms, etc. As an example, the package 60 shown in FIG. 1 includes a double sided sticker (marked 65) for attaching the package to a surface of the vehicle. As part of some aspects of the invention, there is significance in the type of fastening, coupling or attachment means 65 that is used. The specific and type of the fastening, coupling or attachment means 65 which is appropriate for such aspects is explicitly specified below as part of the description of the respective aspects. In other aspects of the present invention, where fastening, coupling or attachment means 65 is/are not specifically specified, any appropriate fastening, coupling or attachment means 65 may be used. As mentioned above, the casing 60 with the components of the WIDD 100 may be attached to various areas of the vehicle. In one example, the casing 60 may be attached to a metallic surface in the vicinity of the fuel inlet of the vehicle.

As mentioned above, the tamper protection sensor 50 may measure certain physical properties. In further embodiments, the tamper protection sensor 50 may be configured for sensing a physical property related to at least one essential functional component of the WIDD 100. In still further embodiments, the physical property is affected by an attempt to physically remove the at least one essential functional component of the WIDD 100 from the surface to which it is attached after initialization. In yet further embodiments of the invention, an essential functional component is one or a combination of the following: the storage module 20, the processing module 10, the communication module 30, the antenna 32 and/or the power source 40.

The readings from the tamper protection sensor 50 may be monitored by the processing module 10 for detecting an indication of a tampering attempt. In some embodiments, the tamper protection sensor 50 is configured to measure physical properties which are measurably affected by a separation or removal of the casing 60 or of components of the WIDD 100 packaged within the casing 60 form the surface to which the casing 60 is attached. As will be described below, the processing module 10 is configured to routinely monitor the readings from the tamper protection sensor 50.

According to some embodiments, the WIDD 100 may be initialized or the tamper protection feature of the WIDD 100 may be activated after the casing 60 is attached to the surface of the vehicle where it is to remain throughout the WIDD's 100 service. Activation/initialization following attachment of the casing 60 to the surface where it is to remain allows the tamper protection sensor 50 to provide, from the start, readings which are in line with the physical conditions which exist when the WIDD 100 or the casing 60 is attached to the surface to which it is supposed to remain attached throughout its service.

Before discussing certain types of tamper protections sensors 50 and their use in different WIDDs 100 according to several aspects of the invention or possibly together in a single WIDD 100, the common aspects of the interaction between the proposed tamper protection sensors 50 and the processing module 10 are described. As mentioned above, in some embodiments, the processing module 10 may routinely receive or obtain updated readings from the tamper protection sensor 50. For example, the processing module 10 may be configured to poll the tamper protection sensor 50 at a certain frequency. The processing module 10 may be adapted to process the sampled data from the tamper protection sensor 50 to determine if a tamper attempt is taking place.

According to some embodiments, the WIDD 100 may be configured so that the physical property measured by the tamper protection sensor 50 remains substantially constant as long as it remains attached to the surface to which it is secured. Some possible configurations which support this requirement are described below. According to some embodiments, the processing module 10 may be adapted to determine that a tamper attempt is taking place when the readings from the tamper protection sensor 50 are in compliance (or are in violation of) one or more predefined rules, criteria, thresholds and/or functions. According to still further embodiments, the processing module 10 may be adapted to determine that a tamper attempt is taking place when the readings from the tamper protection sensor 50 show a relatively large difference between a first group of readings, the first group consisting of one or more most recent readings, and a second group of readings, which consist of one or more readings preceding the first group of readings. The difference represents a relatively sharp and abrupt change in a physical property which is measurable by the tamper protection sensor 50. It would be appreciated that such a relatively sharp and abrupt change may be indicative of a respective change in the physical circumstances under which the tamper protections sensor 50 operates, and since, as was mentioned above, the WIDD 100 may be configured so that the physical property measured by the tamper protection sensor 50 remains substantially constant as long as it remains attached to the surface to which it is secured, the change may indicate that an attempt to tamper with the WIDD 100 which involves, for example, removal of at least some of its components, is taking place. The processing module 10 may be responsive to such drastic and abrupt changes for initiating the disablement action or procedure.

In some embodiments, the polling frequency or the frequency at which the processing module 10 interrogates the tamper protections sensor 50 may be relatively high, for example a fraction of a second. Such high frequency may substantially reduce the risk of a culprit being able to recreate the physical circumstances which would provide readings that are within what the processing module 10 is expecting to read, and thus evade the triggering of the disablement action or procedure and the bricking of the WIDD 100. In addition, the processing module 10 may be configured so that it is sensitive enough to changes in the physical circumstances so that it is able to reliably detect actual tamper attempts while maintaining false detection at a relatively low rate, and in some embodiments, at a rate of virtually zero. It would be appreciated that natural environmental changes are moderate, gradual and are typically very slow. Thus it may be highly challenging to maintain environmental changes during an attempt to remove a WIDD 100 at a rate which is close enough to natural changes so as to evade triggering the disablement action or procedure.

For example, according to some embodiments of the invention, the processing module 10 may be adapted to store in a buffer or in the storage module 20 a certain number of readings which were previously obtained from the tamper protection sensor 50, and the decision whether the readings from the tamper protection sensor 50 are indicative of a tamper attempt may be based on a plurality of recent readings rather than just on one. In accordance with one example, the processing module 10 may be adapted to calculate a moving average based on a certain number (two or more) of most recent readings obtained from the tamper protection sensor 50.

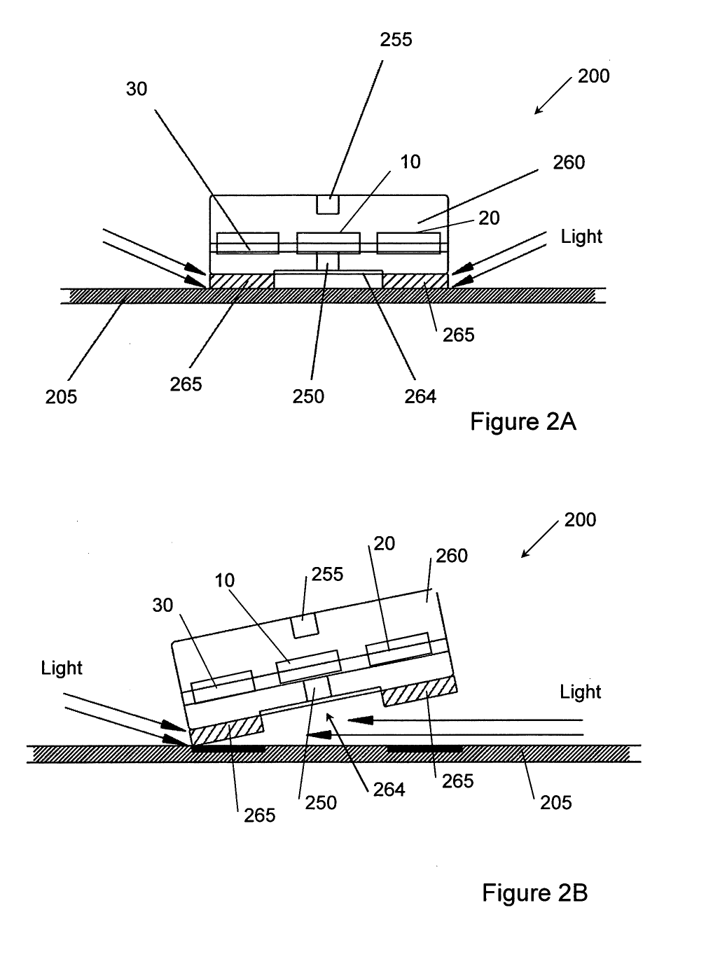

Having described in detail various details of a generic WIDD 100 which is compatible with several aspects of the present invention, there is now provided a description of unique features of different aspects of the invention. However, it should be noted that not all the features described as part of the description of any of the aspects of the invention discussed below are exclusive for that particular aspect, and that some features may be common to more than one aspect. Moving now to a description of a WIDD wherein the tamper protection sensor includes a light sensitive sensor, reference is made to FIG. 2A, which is a block diagram illustration of a WIDD with a light sensitive tamper protection sensor while secured to a surface to which it is supposed to remain attached throughout its service, according to some embodiments of the invention. Additional reference is made to FIG. 2B, which is a block diagram illustration of a WIDD with a light sensitive tamper protection sensor while the WIDD is lifted off the surface to which it is supposed to remain attached throughout its service, according to some embodiments of the invention.

In FIGS. 2A and 2B there is shown a WIDD 200 with light sensitive tamper protection. The WIDD 200 shown in FIGS. 2A and 2B includes a processing module 10, a storage module 20 and a communication module 30, each of which is functionally similar to the corresponding components of the WIDD shown in FIG. 1 and discussed above. The WIDD 200 in FIGS. 2A and 2B may include other elements of the WIDD shown in FIG. 1 and discussed above. Such additional optional elements have been removed from FIGS. 2A and 2B for simplicity. The WIDD 200 shown in FIGS. 2A and 2B further includes a light sensitive sensor 250 serving as a tamper protection sensor. According to some embodiments, the light sensitive sensor 250 may be adapted to measure the amount of light which impinges thereupon. In one example, the output of the light sensitive sensor 250 may be an analog signal representing a measure of the amount of light the sensor 250 is exposed to. Further by way of example, the processing module 10 may obtain the analog signal from the sensor 250, amplify it and perform an A/D conversion for enabling digital processing of the sensor's 250 readings.

According to some embodiments, the WIDD 200 with the light sensitive tamper protection may include a casing 260 which is substantially opaque except for at least a portion 264 of the face of the casing which is intended for being attached to the surface 205 of the vehicle that is substantially transparent to light. The substantially transparent portion 264 of the casing may be achieved by leaving a window 264 through the face of the casing that is to be attached to the surface 205. The light sensitive sensor 250 may be positioned inside the casing 260 in a manner to provide good exposure of the light sensitive sensor 250 to light entering the inner portion of the casing through the window 264. The configuration of the casing 260, the window 264 and the light sensitive sensor 250 may provide a good optical seal while the casing 260 is attached to the surface 205 of the vehicle onto which it is supposed to remain secured throughout its service (FIG. 2A), and configuration would allow light to penetrate into the casing 260 and impinge upon the light sensitive sensor 250 when the casing is lifted from the surface 205 of the vehicle (FIG. 2B).

According to some embodiments, the transparent area 264 of the casing's 260 surface may be completely surrounded with a double sided foam sticker 265 (adhesive) which is used in this case as the attachment means. The foam sticker 265 also provides an optical seal by virtue of its opacity and provides a good seal between the casing 260 and the surface 205 of the vehicle. Thus, inside the casing 260 a virtually dark environment is achieved and a minimal amount of light would impinge upon the sensor 250 so long as the casing 260 is attached to the surface 205 with the foam sticker 265 between the casing 260 and the surface 205 completing the optical seal. It would be appreciated, that achieving an optically sealed environment within the internal portion of the casing 260 may provide a more accentuated or significant difference between the optical environment within casing 260 and outside the casing 260, even at poor ambient light conditions.

In some embodiments, the WIDD 200 may be initialized after it is attached to the surface 205 of the vehicle where it is to remain secured throughout its service. The WIDD's 200 tamper detection procedure may be initialized with parameters which represent a physical environment which is similar to that which would exist when the WIDD 200 and/or casing 260 is properly attached to the surface 250 to which it is supposed to be secured throughout the operation of the WIDD 200. In some embodiments, in case the WIDD 200 is not properly attached to the surface 205 of the vehicle, the inner part of the casing 250 would be exposed to a certain level of ambient light and the readings from the light sensitive sensor 250 would reflect that. The processing module 10 may respond to such readings by disabling the WIDD 200, indicating that the installation has failed and that the WIDD 200 should be reinitialized after the appropriate adjustment and correction steps are performed. Thus, it would be appreciated that the tamper protection sensor of the WIDD may also be used to provide a significant advantage by forcing correct installation of the WIDD and proper attachment to the surface to which it is supposed to be secured throughout the operation. It would be further appreciated that improper attachment may lead to accelerated wear and tear of the WIDD and should preferably be avoided.

The light sensitive sensor 250 together with the processing module 10 are configured so that when an attempt is made to remove the WIDD 200 from the surface 205 of the vehicle the light sensitive sensor 250 is exposed to ambient light, the processing module detects the light surge, and responds by initiating the disablement action or procedure and thus blocks the operation of the WIDD 200 (FIG. 2B), rendering it useless.

According to some embodiments of the invention, the light sensitive sensor 250 and the processing module 10 may be configured so that even moonlight will be detected and regarded as a significant increase in the amount of light exposure and will cause the WIDD to become disabled.

According to further embodiments of the invention, the WIDD 200 may be configured so that, once it is blocked, returning it to darkness would not unblock it. The WIDD 200 may be re-enabled again only by using a particular hardware component and/or software program which are not readily available and which cannot be readily replicated and/or utilized. According to some embodiments, blocking of the WIDD 200 may be achieved by changing a certain parameter or a flag within the memory or within storage area provided by the storage module 20. In further embodiments, the processing module 10 may execute some routine which checks the parameter or flag from time to time or in response to certain events/requests. The processing module 10 may be configured to enable the operation of the WIDD 200 unless the parameter or flag is set to a certain value or state which is indicative of a disablement of the WIDD 200.

It would be appreciated that during normal operation the external surface of the casing 260 may be exposed to direct sun or moon rays or to light from artificial sources. Small amounts of these rays may penetrate through the casing 260 and possibly to a larger extent through the foam sticker 265 and may cause erroneous blocking of the WIDD 200. As mentioned above, the processing module 10 may significantly reduce such erroneous disablement of the WIDD 200 by adapting the tamper protection process according to the surrounding environment and in the current context, by adapting the tamper protection process according to the surrounding light level. Thus, during daylight the processing module 10 would allow higher levels of light than during nighttime conditions. The exact level may be derived directly from a current amount of ambient light or may be a predefined level that is selected according to the level of ambient light. As is shown in FIGS. 2A and 2B the amount of ambient light may be determined by using an external light sensitive sensor 255 which reads the ambient light level. According to further embodiments, the external light sensitive sensor 255 may be attached to the outer portion of the casing 260. The readings from the external sensor 255 are received by the processing module 10 and are used to adjust the rules, criteria, thresholds and/or functions that used to determine if a tamper attempt is taking place. The processing module 10 may change the rules, criteria, thresholds and/or functions based on the readings and the change may be directly related to the readings from the external sensor 255 or the change may be in accordance with some predefined parameter that is associated with the readings. It would be appreciated that the use of the external light sensitive sensor 255 may reduce the effectiveness of creating artificial dark conditions around the casing 260 in order to trick the light sensitive internal sensor 250. Any such attempt to create a dark environment to reduce the chances that the light sensitive internal sensor 250 will detect changes in the physical environment during the removal attempt, may result in the internal sensor 250 or the processing of the signals therefrom becoming more sensitive.

According to still further embodiments of the invention, the processing module 10 may also be adapted to monitor from time to time the external sensor 255 in order to detect tamper attempts related to that sensor 255 and the processing module 10 may be configured to block data or the WIDD 200 in case a tamper attempt with respect to the external light sensor 255 is detected. In other embodiments, in response to detecting a tamper attempt with respect to the external sensor 255, the processing module 10 may automatically increase sensitivity of the internal sensor 250 and/or the sensitivity in the processing of the reading from the internal sensor 250.

Having described in detail the structure of WIDD which includes a light sensitive sensor which is used at the tamper protection sensor, there is now provided a short description of one example of a method of operation of the WIDD with the light sensitive sensor. Some of the details in the following example are provided as one possibility out of several possible implementations and should not be regarded as limiting. In some embodiments, installation of the WIDD may commence with a technician (or any other user) uncovering a wax paper covering a foam sticker at the bottom of a casing of the WIDD and sticking a non-initialized WIDD to a surface of a vehicle at a position where the WIDD is to remain throughout its service. For example, the service-man may stick the WIDD on a substantially opaque surface in the vicinity of the vehicle's fuel inlet. A substantially transparent window may be located at the button face of the casing, and by sticking the casing of the substantially opaque WIDD on the substantially opaque surface of the vehicle, a good optical seal may be achieved, preventing significant amounts of light from entering the inside of the casing through the substantially transparent window at the bottom of the casing. An external light sensor (if such exists) may be located on an external surface of the casing and may be used to sense surrounding light levels in a manner described in detail above.

In some embodiments, the technician may be required to initialize the WIDD with a dedicated handheld programmer. In further embodiments, the initialization causes the processing module to save current readings of the sensor(s). For example, the saved data may be used as a reference for future readings. Still further by way of example, the initial readings during the initiation of the WIDD may be used as a reference for certain adaptive measures implemented by the processing module, and for example, such adaptive measures are constrained by some parameter related to the initiation readings.

The processing module may be configured to intermittently wake up, for example at a predefined frequency, and further by way of example, a few times a second and read the light level as measured by the light sensitive sensor. Still further by way of example, at each iteration, the processing module compares the current reading to one or more previous readings. In some embodiments, if the change in light level is bigger than expected (e.g., larger than a predefined delta) the disablement action or procedure may be initiated. According to some embodiments, if the change is acceptable (e.g., below a predefined threshold) the readings are recorded, for example in a buffer, and the WIDD is allowed to continue operating. The readings may be used stored in the buffer and may be used for comparing against future readings.

Where an external light sensitive sensor is included, the processing module may compare the readings from the external sensor to the reading from the internal light sensitive sensor. By way of example, if the two readings indicate that inside the casing and on its outside are within some predefined range, the processing module may block the data. As mentioned above, there should be a significant difference between the amount of light within the casing—which is incident upon the internal light sensor, and the amount of light outside the casing—which is incident upon the external light sensor, even in relatively poor light conditions (e.g., moonlight).

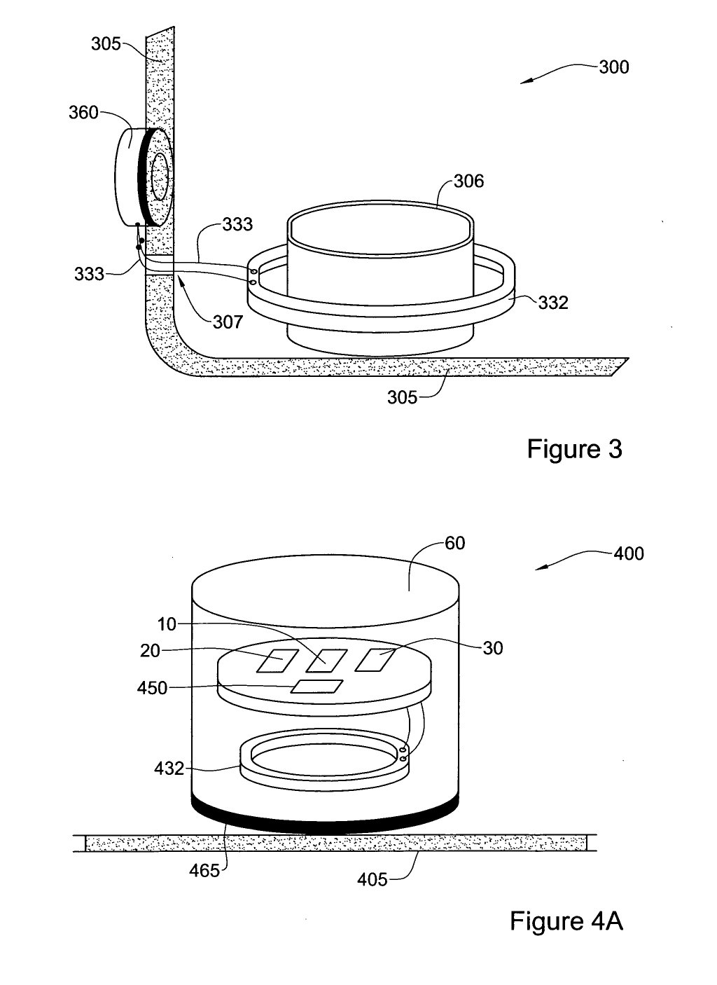

Having described an aspect of the invention wherein a light sensitive sensor is used to protect against lifting of a WIDD from a surface onto which it is attached and whereon it is supposed to remain secured throughout its service, there is now provided a description of a WIDD wherein the tamper protection sensor includes an inductance sensor, according to a further aspect of the invention. Reference is now made to FIG. 3, which is a block diagram illustration of a WIDD with an inductance sensor, according to some embodiments of the invention. According to some embodiments, the WIDD 300 includes a processing module and a communication module, and possibly also a storage module. These components are functionally similar to the corresponding components of the WIDD shown in FIG. 1 and discussed above, and for simplicity these components are not shown in FIG. 3. The WIDD 300 in FIG. 3 may include other elements of the WIDD shown in FIG. 1 and discussed above. Such additional optional elements have been removed from FIG. 3 for simplicity. According to some embodiments, the communication module of the WIDD may be separated and the antenna 332 may be physically removed from the transceiver.

In some embodiments, the processing module, the storage module and the transceiver may be packaged together within a casing 360. The antenna 332 and the functional components within the casing 360 may be operatively connected to one another using wires 333. According to some embodiments, the wires 333 may be passed through a relatively small hole 307 passing through a substantially solid surface 305 with the casing 360 and the antenna 332 located at different sides of the surface 305. For example, the antenna 332 may be located around the vehicle's fuel inlet and the casing 360 with the remaining components of the WIDD 300 may be attached to an inner surface 305 of the vehicle's trunk compartment. The two parts of the WIDD 300 may be interconnected by wires 333 passing through holes 307 in the vehicle's surface(s) 305.

The WIDD 300 includes an inductance sensor (not shown), that is typically placed within the casing 360 and which is adapted to measure the inductance of the antenna 332. In one example, the output of the inductance sensor may be an analog signal representing a measure of the amount of inductance created by the antenna 332 and which the sensor is exposed to. Further by way of example, the processing module may obtain the analog signal from the inductance sensor, and perform an A/D conversion for enabling digital processing of the sensor's readings.

In some embodiments, the hole 307 may be small enough to prevent the passage of either part of the WIDD 300 to the other side, the casing 360 with the components therewithin on the one hand, and the antenna 332 on the other cannot pass through the hole 307. In some embodiments, the hole 307 is substantially smaller than either the casing 360 or the antenna 332 and is only large enough to allow passage of the wires 333 therethrough. Therefore, a culprit attempting to impermissibly remove the WIDD 300 would have to sever the wires 333 connecting the two parts of the WIDD 300 and remove the two parts separately. It would be appreciated that severing the wires 333 would create a significant change in the amount of inductance detected by the inductance sensor, since the wires 333 connected to the antenna 332 which generate a substantial inductance are not longer connected to the antenna 332.

According to some embodiments, the inductance sensor together with the processing module are configured so that when an attempt is made to remove the WIDD 300 from the vehicle, the processing module identifies from the readings of the inductance sensor, and detects that the inductance has changed in a significant manner and abruptly. The processing module may be configured to respond to detection of such substantial and abrupt change by initiating the disablement action or procedure and thus blocking the operation of the WIDD 300, rendering it useless.

In some embodiments, the frequency at which the processing module interrogates the inductance sensor may be relatively high, for example, a fraction of a second. Such high frequency may substantially reduce the risk of a culprit being able to sever the wires 333 and reconnecting them (bypassing the hole 307) before the processing module detects the change and disabling the WIDD 300. In addition, the inductance sensor and the processing module may be configured so that they are sensitive enough to changes in the inductance of the antenna 332 to reliably detect actual tamper attempts while maintaining false detection to be relatively low. For example, the inductance sensor and the processing module may be configured and are sufficiently sensitive so that they are able to detect elaborate tamper attempts. For example, the inductance sensor and the processing module may be configured so that they are sensitive enough to detect changes induced by first connecting the two parts of the WIDD 300 via some bypass and, only after the bypass is in place, severing the wires 333 passing through the hole 307. It would be appreciated that changes in the inductance of the antenna 332 which are a result of natural environmental changes are moderate, gradual and are typically very slow. According to some embodiments, the inductance sensor and the processing module may be configured to ignore small and gradual changes and thereby reduce false detection of tamper attempts, and at the same time may be sensitive enough to detect any change whose inductance signature is inconsistent with changes in the natural environment. Such changes may be characterized by a faster rate and more drastic change and non-transient values which cannot be a reasonable result of environmental changes. Various techniques which may be implemented by the processing module in order to reduce the risk of false detection, including various averaging and similar mechanisms, were discussed above.

In some embodiments, during installation of the WIDD 300, the two parts of the WIDD 300 are initially placed at their respective positions in the vehicle. As mentioned above, each one of the two parts of the WIDD 300 is placed at a different side of at least one solid surface and are connected to one another by wires 333 which pass through a hole 307. The hole 307 is relatively small and typically would only allow the wires 333 to pass therethrough. The WIDD 300 is now ready for being initialized.

After mounting of the WIDD 300 is complete, a technician may resume installation of the WIDD 300. The next step of the installation process would be to initialize the WIDD 300. In some embodiments, the WIDD 300 is initialized by a hardware programmer that is available and used within a controlled environment, such as a special support facility. After the initialization, the processing module monitors the inductance of the antenna at a predefined frequency (substantially short intervals). When an attempt is made to remove the WIDD 300 from the vehicle, the culprit would be required to disconnect the antenna 332, because the antenna 332 cannot pass it through the small hole 307 (it is large enough only for the wires 333). The inductance sensor senses the inductance, and the processing module monitors the readings by the inductance sensor at a relatively high rate. If the processing module detects that the readings indicate an abrupt and significant drop in the inductance, it initiates a disablement action or procedure. The inductance sensor and the processing module are configured so that even if an attempt is made to connect a short or another antenna between the wires before disconnecting the original antenna 332, the change in inductance resulting from such activity is detected and the disablement action or procedure is initiated. Once the WIDD 300 is disabled, reconnecting the antenna 332 (or otherwise restoring the same level of inductance) will not re-enable the WIDD 300. The WIDD 300 can only be used again after initialization by the external programmer.

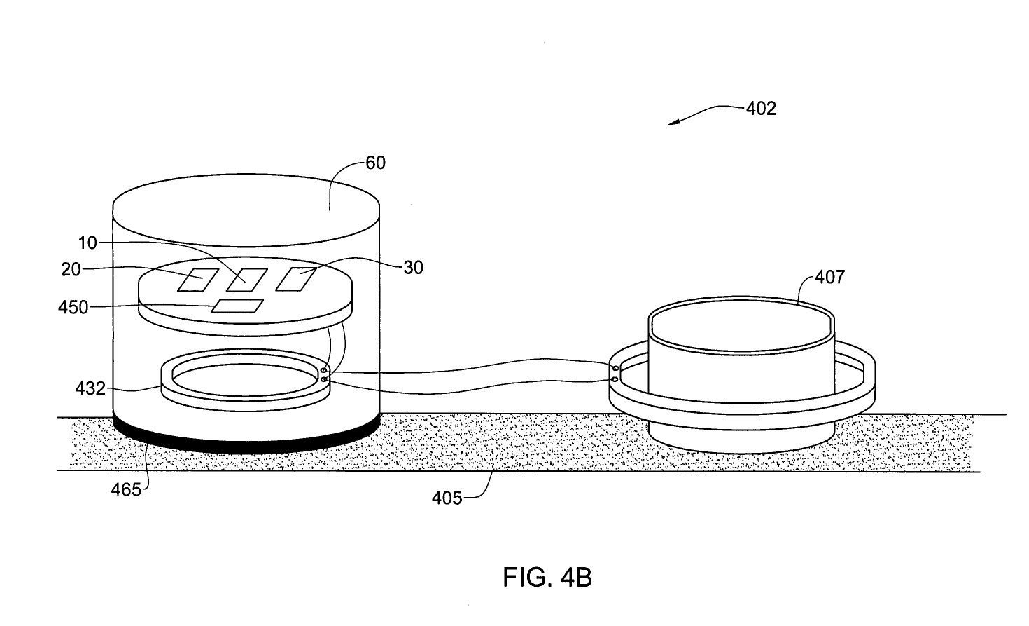

A further aspect of the invention involving a WIDD wherein the tamper protection sensor includes a metal proximity detector is now described. Reference is now made to FIGS. 4A and 4B which are block diagrams of two respective implementations of a WIDD with a metal proximity detector, according to some embodiments of the invention. According to some embodiments, the WIDDs 400 and 402 in FIGS. 4A and 4B, respectively, each include a processing module 10 and a communication module 30, and possibly also a storage module 20. The WIDDs 400 and 402 may also each include fastening, coupling or attachment means 465 for securing the WIDD 400 or 402 to a surface of a vehicle 405 on which it is intended to remain throughout its service. The above components of the WIDD 400 and 402 are functionally similar to the corresponding components of the WIDD shown in FIG. 1 and discussed above. The WIDDs 400 and 402 in FIGS. 4A and 4B may include other elements of the WIDD shown in FIG. 1 and discussed above. Such additional optional elements have been removed from FIGS. 4A and 4B for simplicity.

According to some embodiments, each one of the WIDDs 400 and 402 may further include a metal proximity detector 450. In some embodiments metal proximity sensor 450 includes at least an inductance sensor. In some embodiments the WIDDs 400 and 402 may also include an inductor 433, and the metal proximity sensor 450 is adapted to determine the inductance of the inductor 433. In some embodiments, the inductor 433 is attached or secured in the vicinity of a metal surface 405 and 407 of the vehicle. The metal surface 405 and 407 affects the inductance of the inductor 433. More specifically the proximity of the metal surface 405 and 407 affects the inductance of the inductor 433. FIG. 4C is a graph showing the variation of an inductor's inductance as a function of the inductor's distance from a metal surface. As is shown in FIG. 4C, as the distance between the inductor and the metal surface grows, the level of inductance is diminished. For a typical inductor and metal surface and under the relevant operating conditions, inductance is inversely affected by distance.

In FIGS. 4A and 4B and according to some embodiments, the WIDDs 400 and 402 include a ring antenna which is also used as the inductor 433. The antenna 433 is, for example, a ring type antenna and it exhibits noticeable inductance when attached to a metal surface 405 and 407 of the vehicle. It should be appreciated however, that in other embodiments, a dedicate inductor 433 may be used and may be coupled to any other essential component of the WIDD 400 so that lifting of the essential component from a surface to which that component is attached and where it is supposed to remain secured would trigger the disablement action or procedure. In FIG. 4A the antenna is an internal ring antenna 433 which is secured in the proximity of a metallic surface 405 by virtue of being fitted within the casing 460 of the WIDD 400. The casing 460 of the WIDD 400 shown in FIG. 4A may be arranged so that the antenna 433, is secured to an area of the casing 460 that is relatively close to the metallic surface 405 of the vehicle to which the casing 460 is attached. As will be described in further detail below, the processing module 10 together with the metal proximity sensor 450 and the inductor 433 may be utilized to protect against attempts to lift or otherwise remove the WIDD 400 and in particular the inductor (or ring antenna) 433 integrated within the casing 460 of the WIDD 400.

In FIG. 4B the antenna is an external ring antenna 433 which is physically removed from the other components of the WIDD 402. The external antenna 433 is connected to some of the other functional of the WIDD 402, such as the transceiver and the processing module 10 by wires. According to some embodiments, the external ring antenna 433 may be attached to or secured in the in the proximity of a metallic surface 407. In FIG. 4B and according to some embodiments, the antenna 433 may be fitted around the metallic fuel inlet of the vehicle which the WIDD 402 is intended to service.

According to some embodiments, the metal proximity detector 450 together with the processing module 10 are configured to detect when an attempt is made to remove the WIDD 400 or 402 from the surface 405 and 407 onto which it is attached. In further embodiments, the processing module 10 is configured to identify from the readings of the metal proximity detector 450 that the inductance of the inductor 433 has changed in a significant manner and abruptly. The processing module 10 may be configured to respond to detection of such substantial and abrupt change by initiating the disablement action or procedure and thus blocking the operation of the WIDD 400 or 402, rendering it useless.

In some embodiments, in addition to responding to readings which indicate an extraordinary rate of change, the processing module 10 may respond to any drop (at any rate) in the amount of inductance of the inductor 433 below a certain threshold by triggering the disablement action or procedure being triggered. In further embodiments, the processing module 10 may be configured to initiate the disablement action or procedure in case the amount of inductance is at a level which is less than what is reasonable for maintaining the inductor 433 in close proximity to the surface 405 or 407.

In some embodiments, the frequency at which the processing module 10 interrogates the metal proximity detector 450 may be relatively high, for example, a fraction of a second. Such high frequency may substantially reduce the risk of a culprit being able to remove the inductor 433 from the surface onto which it is secured before the processing module 10 detects the change in inductance and disables the WIDD 400. Since the inductor 433 is either an essential functional component of the WIDD 400 or is packaged together with such essential functional components of the WIDD 400, the removal of the inductor 433 is regarded as an attempt to remove the WIDD 400 from the surface or surfaces to which it is attached and where it is supposed to remain secured throughout it service.

In addition, the metal proximity detector 450 and the processing module 10 may be configured so that they are sensitive enough to changes in the inductance of the inductor 433 to reliably detect actual tamper attempts while maintaining false detection to be relatively low. It would be appreciated that changes in the inductance which are a result of natural environmental changes are moderate, gradual and are typically very slow. According to some embodiments, the metal proximity detector 450 and the processing module 10 may be configured to ignore small and gradual changes and thereby reduce false detection of tamper attempts, and at the same time may be sensitive enough to detect any change which is not a result of change in the natural environment. Such changes may be characterized by a faster rate and more drastic change and non-transient values which cannot be a reasonable result of environmental changes. Various techniques which may be implemented by the processing module 10 in order to reduce the risk of false detection, including various averaging and similar mechanisms, were discussed above.

In some embodiments, during installation of the WIDD 400, the WIDD 400 is attached to a desired location on a certain surface 405 of the vehicle which the WIDD 400 is intended to service. The WIDD 400 is attached to the surface 405 of the vehicle using a fastening, coupling or attachment means 465. For example, the casing 460 of the WIDD 400 may be attached to the surface 405 of the vehicle. An inductor 433 may be packaged within the casing 460 so that it is secured to an area of the casing 460 that is relatively close to the metallic surface 405 of the vehicle to which the casing 460 is attached. In a further embodiment, the inductor is external to the casing 460 and is independently attached to a metallic surface 407 of the vehicle. The external inductor 433 may be coupled to an essential component of the WIDD 400 and may be used to protect against the lifting or removal of that essential component. In still a further embodiment, the external inductor is an external ring antenna 433, which is, in-and-of-itself, both an inductor and an essential component of the WIDD 400.

After mounting of the WIDD 400 is complete, a technician may resume installation of the WIDD 400. The next step of the installation process would be to initialize the WIDD 400. In some embodiments, the WIDD 400 is initialized by a hardware programmer that is available and used within a controlled environment, such as a special support facility. After the initialization, the processing module 10 monitors the inductance of the inductor 433. When an attempt is made to remove the WIDD 400 from the vehicle, the culprit would be required to remove the inductor 433 from the surface 405 or 407 of the vehicle to which it is attached. The inductor within the metal proximity detector 450 senses a change in the inductance of the inductor 433, and the processing module 10 which monitors the readings by the metal proximity detector 450 at a relatively high rate detects that the readings indicate an abrupt and significant drop in the inductance of the inductor 433. The processing module 10 responds to the abrupt drop in the inductance by initiating a disablement action or procedure. The disablement procedure or action is such that once the WIDD 400 is disabled it cannot be reactivated by restoring the inductance level of the inductor 433 to substantially the level before the detected drop (although as mentioned above, highly transient changes may be regarded as false readings and may be ignored). Once the WIDD 400 is disabled, it can only be used again after initialization by an external programmer.

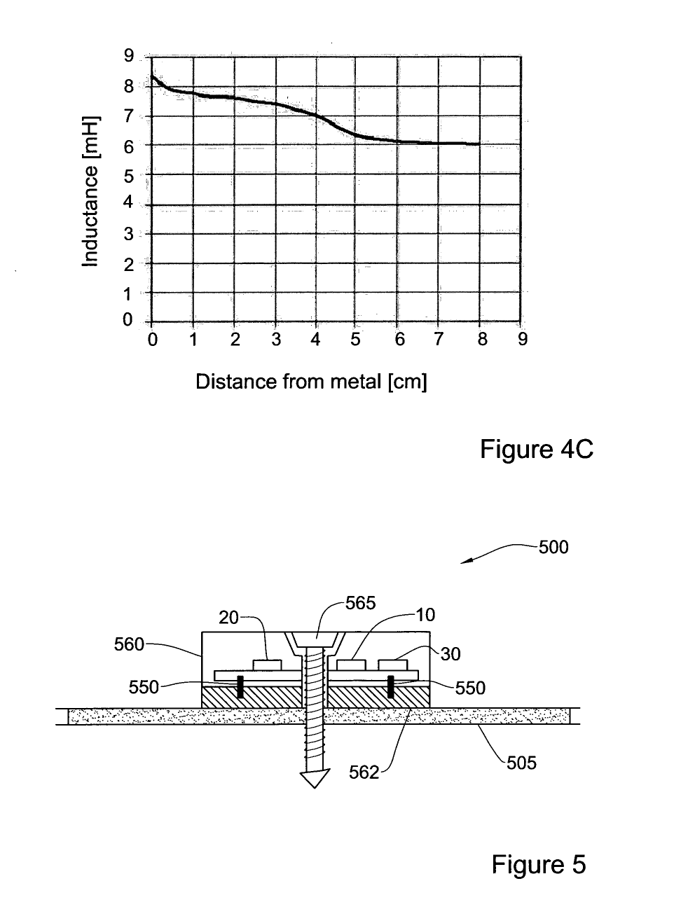

Moving now to a description of yet a further aspect of the invention, there is provided a WIDD wherein the tamper protection sensor includes a pressure sensor, according to a further aspect of the invention. Reference is now made to FIG. 5, which is a block diagram illustration of a WIDD with a pressure sensor, according to some embodiments of the invention. According to some embodiments, the WIDD 500 includes a processing module 10 and a communication module 30, and possibly also a storage module 20. These components are functionally similar to the corresponding components of the WIDD shown in FIG. 1 and discussed above. The WIDD 500 in FIG. 5 may include other elements of the WIDD shown in FIG. 1 and discussed above. Such additional optional elements have been removed from FIG. 5 for simplicity.

According to some embodiments, the components of the WIDD 500 may be formed or shaped so that they fit inside the package 560. According to some embodiments, the WIDD 500 also includes a fastening, coupling or attachment means 565 for enabling attachment of the casing 560 to the surface 505 of the vehicle. In further embodiments, the fastening, coupling or attachment means 565 may be configured to secure the casing 560 to the surface 505 of the vehicle with substantial force. In still further embodiments, the force exerted by the fastening, coupling or attachment means 565 is substantially steady. In FIG. 5 by way of example, a screw is used as the fastening means 565. The screw attaches the WIDD package 560 to the surface 505 of the vehicle with a relatively steady amount of force.

The WIDD 500 may also include a pressure sensor 550 that is configured to measure the amount of pressure on the button surface of the casing 562. This pressure is the result of pressing of the casing 560 against the surface 505 to which the casing 560 is attached and to which it is supposed to remain attached throughout the service time of the WIDD 500. In FIG. 5 and according to some embodiments of the invention, the pressure sensor 550 is positioned between the casing 560 and the surface rather than being placed within the casing 560. In one example, the output of the pressure sensor 550 may be an analog signal representing a measure of the amount of force exerted on the sensor 550. The processing module 10 may obtain the analog signal from the pressure sensor 550, and perform an A/D conversion for enabling digital processing of the sensor's readings.

According to some embodiments, the pressure sensor 550 together with the processing module 10 are configured to detect when an attempt is made to remove the WIDD 500 from the surface 505 onto which it is attached. In further embodiments, the processing module 10 is configured to identify from the readings of the pressure sensor 550 that the attachment force has changed in a significant manner and abruptly. The processing module 10 may be configured to respond to detection of such substantial and abrupt change by initiating the disablement action or procedure and thus blocking the operation of the WIDD 500, rendering it useless. In some embodiments, in addition to responding to readings which indicate an extraordinary rate of change, the processing module 10 may respond to any drop (at any rate) in the amount of pressure below a certain threshold by triggering the disablement action or procedure being triggered. In further embodiments, the processing module 10 may be configured to initiate the disablement action or procedure in case the amount of pressure is at a level which is less than what is reasonable for maintaining the casing 560 attached to the surface 505.

In some embodiments, the frequency at which the processing module 10 interrogates the pressure sensor 550 may be relatively high, for example, a fraction of a second. Such high frequency may substantially reduce the risk of a culprit being able to release the fastening, coupling or attachment means 565 before the processing module detects the change and disables the WIDD 500. In addition, the pressure sensor 550 and the processing module 10 may be configured so that they are sensitive enough to changes in the pressure exerted on the button surface of the casing 562 to reliably detect actual tamper attempts while maintaining false detection to be relatively low. It would be appreciated that changes in the pressure which are a result of natural environmental changes are moderate, gradual and are typically very slow. According to some embodiments, the pressure sensor 550 and the processing module 10 may be configured to ignore small and gradual changes and thereby reduce false detection of tamper attempts, and at the same time may be sensitive enough to detect any change which is not a result of change in the natural environment. Such changes may be characterized by a faster rate and more drastic change and non-transient values which cannot be a reasonable result of environmental changes. Various techniques which may be implemented by the processing module 10 in order to reduce the risk of false detection, including various averaging and similar mechanisms, were discussed above.

In some embodiments, during installation of the WIDD 500, the WIDD 500 is attached to a desired location on a certain surface 505 of the vehicle which the WIDD 500 is intended to service. The WIDD 500 is attached to the surface of the vehicle using a fastening, coupling or attachment means 565. For example, the casing 560 of the WIDD 500 may be attached to the surface 505 of the vehicle. The casing 560 may be attached to the surface 505 of the WIDD 500 with substantial force, giving rise to a significant amount of pressure on the surface of the casing 560 that is attached to the surface 505 of the vehicle. The WIDD 500 is now ready for being initialized.

After mounting of the WIDD 500 is complete, a technician may resume installation of the WIDD 500. The next step of the installation process would be to initialize the WIDD 500. In some embodiments, the WIDD 500 is initialized by a hardware programmer that is available and used within a controlled environment, such as a special support facility. After the initialization, the processing module 10 monitors the pressure on the surface 562 of the casing that is attached to the surface 505 of the vehicle. When an attempt is made to remove the WIDD 500 from the vehicle, the culprit would be required to remove the casing 560 from the surface 505 of the vehicle to which it is attached. The pressure sensor 550 senses the attempt to release the casing 560 from the surface 505 to which it is attached, and the processing module 10 which monitors the readings by the pressure sensor 550 at a relatively high rate detects that the readings indicate an abrupt and significant drop in the amount of pressure exerted on the casing that is attached to the vehicle. The processing module 10 responds to the abrupt drop in the amount of pressure by initiating a disablement action or procedure. The disablement procedure or action is such that once the WIDD 500 is disabled it cannot be reactivated by restoring the pressure on the surface 562 to substantially the level before the detected drop (although as mentioned above, highly transient changes may be regarded as false readings and may be ignored). Once the WIDD 500 is disabled, it can only be used again after initialization by an external programmer.

In the above description reference was made to several aspects of the invention, It would be appreciated that any one of the aspects described above and any embodiments thereof may be implemented in conjunction with any one of the other aspects of the invention and in conjunction with any embodiments thereof.

While certain features of the invention have been illustrated and described herein, many modifications, substitutions, changes, and equivalents will occur to those skilled in the art. It is therefore to be understood that the appended claims are intended to cover all such modifications and changes as fall within the true scope of the invention.

1-6. (canceled)

7. A wireless identification device (“WIDD”) with tamper protection, comprising:
a. a transceiver;
b. an antenna operatively connected to the transceiver through wires passing through a hole within a substantially solid surface, the hole is small enough to prevent the passage therethrough of either the antenna or the transceiver;
c. a processor adapted to detect a relatively sharp and abrupt non-transient change in the level of the inductance of the antenna which corresponds to a severing of the wires connected to the antenna and the processor is responsive to the change for initiating a disablement action or procedure.

8. The device according to claim 7, wherein the antenna is a ring type antenna.

9. The device according to claim 7, wherein the antenna is fitted around a metallic fuel inlet.

10. The device according to claim 7, wherein the processor is responsive to the rate of change of the inductor's inductance.

11. The device according to claim 10, wherein the processor is responsive to any drop, at any rate, in the amount of inductance of the inductor below a predefined threshold for initiating the disablement action or procedure.

12. The WIDD according to claim 7 further comprising:
a. a storage module adapted to substantially permanently store transaction enabling data in the WIDD;
b. communication module adapted to receive incoming signals and/or to transmit signals to external components of an automatic transaction system, the communication module including the transceiver and is associated with an antenna;
c. a power source for powering components of the WIDD.

13. A wireless identification device (“WIDD”) with tamper protection, comprising:
a. an inductor attachable to or in a vicinity of a metal surface, a contact or a proximity of the inductor to the metal surface significantly affecting its inductance;
b. a tamper protection sensor adapted to measure the inductor's inductance;
c. a processing module operatively connected to the tamper protection sensor, the processing module is responsive to a relatively sharp and abrupt non-transient change in the inductor's inductance level, the change corresponding to a removal of the inductor from the vicinity of the metal surface for initiating a disablement action or procedure.

14. The device according to claim 13, wherein the inductor is an antenna that is additionally used for facilitating communication to and from the WIDD.

15. The device according to claim 14, wherein the antenna is a ring type antenna.

16. The device according to claim 14, wherein the antenna is placed within a casing of the WIDD, the casing is attached to a metallic surface and the antenna is secured to an area of the casing that is relatively close to the metallic surface.

17. The device according to claim 14, wherein the antenna is external to a casing of the WIDD within which other functional components of the WIDD are located.

18. The device according to claim 14, wherein said device further comprises a transceiver and the antenna is physically removed from the transceiver and/or from the tamper protection sensor and is connected to the transceiver through wires.

19. The device according to claim 14, wherein the antenna is fitted around a metallic fuel inlet.

20. The device according to claim 13, wherein the processor is responsive to the rate of change of the inductor's inductance.

21. The device according to claim 20, wherein the processor is responsive to any drop, at any rate, in the amount of inductance of the inductor below a predefined threshold for initiating the disablement action or procedure.

22. The device according to claim 13, wherein the inductor is a dedicated inductor, and wherein the dedicated inductor is coupled to an essential component of the WIDD which is intended to remain in the vicinity of a metal surface, so that removing the essential component from the metal surface causes the inductance of the inductor coupled thereto to be significantly affected.

23. The WIDD according to claim 13, further comprising:
a. a storage module adapted to substantially permanently store transaction enabling data in the WIDD;
b. communication module adapted to receive incoming signals and/or to transmit signals to external components of an automatic transaction system, the communication module including a transceiver and is associated with an antenna;
c. a power source for powering components of the WIDD.

24. The device according to claim 22, wherein the essential functional component is one or a combination of the following: a storage module, the processing module, a communication module, an antenna and/or a power source.
